(19) United States
(12) Patent Application Publication
(10) Pub. No.: US 2022/0305858 A1
(43) Pub. Date: Sep. 29, 2022

(54) SUSPENSION STRUCTURE

(71) Applicant: HONDA MOTOR CO., LTD., Tokyo (JP)

(72) Inventors: Shinsuke Shimoda, Wako-shi (JP); Toshitaka Sugimoto, Wako-shi (JP)

(21) Appl. No.: 17/676,869

(22) Filed: Feb. 22, 2022

(30) Foreign Application Priority Data
Mar. 23, 2021 (JP) 2021-048286

(51) Int. Cl. B60G 7/00; B60G 7/02

(52) U.S. Cl. CPC B60G 7/001; B60G 7/008; B60G 7/02

(57) ABSTRACT

A suspension structure includes a trailing arm that couples a hub support portion supporting a wheel hub to a vehicle body. The trailing arm includes a vehicle body side attachment portion attached to the vehicle body, and a hub side attachment portion attached to the hub support portion. The hub side attachment portion is positioned below a shortest virtual line connecting a center of the vehicle body side attachment portion and a rotation center of the wheel hub.

### CROSS-REFERENCE TO RELATED APPLICATION

Priority is claimed on Japanese Patent Application No. 2021-048286, filed on Mar. 23, 2021, the contents of which are incorporated herein by reference.

### BACKGROUND

### Field of the Invention

The present invention relates to a suspension structure.

### Background

In the related art, a suspension structure including a trailing arm which couples a vehicle body and an axle housing to each other is known (for example, refer to Japanese Unexamined Patent Application, First Publication No. H10-315730).

### SUMMARY

However, in a trailing arm of a suspension structure in the related art, the center of gravity of the trailing arm is located near a shortest virtual line connecting a vehicle body attachment point with respect to a vehicle body and a center of an axle, and thus a torsional rigidity thereof is high. For this reason, in a vibration mode in which a wheel attached to a hub vibrates in a vehicle width direction, the wheel and the trailing arm vibrate at the same phase, an input to the vehicle body attachment point becomes large, and vibration from the wheel is likely to be transferred to the vehicle body.

An object of an aspect of the present invention is to provide a suspension structure in which vibration of a vehicle body can be curbed.

A suspension structure according to a first aspect of the present invention includes a trailing arm that couples a hub support portion supporting a wheel hub to a vehicle body. The trailing arm includes a vehicle body side attachment portion attached to the vehicle body, and a hub side attachment portion attached to the hub support portion. The hub side attachment portion is positioned below a shortest virtual line connecting a center of the vehicle body side attachment portion and a rotation center of the wheel hub.

According to this constitution, the hub side attachment portion is positioned below the shortest virtual line connecting the center of the vehicle body side attachment portion and the rotation center of the wheel hub. For this reason, the center of gravity in the trailing arm can be away from the center of vibration, and the trailing arm can be likely to swing. In addition, a structure between the vehicle body side attachment portion and the rotation center of the wheel hub can be set such that a torsional rigidity is reduced, and vibration in a vehicle width direction centered in a forward-rearward direction in the vehicle body side attachment portion and vibration in the vehicle width direction centered in the forward-rearward direction in the wheel hub have phases opposite to each other.

According to these, due to torsional vibration in a structure including the trailing arm between the vehicle body side attachment portion and the rotation center of the wheel hub, vibration in the vehicle body side attachment portion and vibration in the wheel hub can be offset. Thus, it is possible to provide a suspension structure in which vibration of the vehicle body can be curbed.

In a second aspect, the trailing arm may have a transverse portion linearly extending in a forward-rearward direction of the vehicle body from the hub side attachment portion, and a hanging portion extending downward from the vehicle body side attachment portion.

According to this constitution, the trailing arm has the transverse portion linearly extending in the forward-rearward direction of the vehicle body from the hub side attachment portion, and the hanging portion extending downward from the vehicle body side attachment portion. Accordingly, a rigidity of the trailing arm with respect to a load from the forward-rearward direction can be enhanced, and the center of gravity can be positioned below while the minimum ground height is secured. Further, the structure including the trailing arm between the vehicle body side attachment portion and the rotation center of the wheel hub can be set such that torsional vibration thereof is facilitated. Thus, vibration from a wheel can be offset, and transfer of vibration to the vehicle body can be curbed.

In a third aspect, the vehicle body side attachment portion may have a bush including a forward-rearward elastic body disposed in a forward-rearward direction of the vehicle body, and an upward-downward elastic body disposed in an upward-downward direction of the vehicle body. The upward-downward elastic body may have a lower hardness than the forward-rearward elastic body.

According to this constitution, the vehicle body side attachment portion has the bush including the forward-rearward elastic body disposed in the forward-rearward direction of the vehicle body, and the upward-downward elastic body disposed in the upward-downward direction of the vehicle body. The upward-downward elastic body has a lower hardness than the forward-rearward elastic body. Accordingly, the vehicle body side attachment portion can be unlikely to be deformed in the forward-rearward direction and can be likely to be distorted centered in the forward-rearward direction. Thus, the structure including the trailing arm between the vehicle body side attachment portion and the rotation center of the wheel hub can be set such that a high rigidity in the forward-rearward direction is maintained and torsional vibration thereof is facilitated. Thus, vibration from the wheel can be offset, and transfer of vibration to the vehicle body can be curbed.

In a fourth aspect, the trailing arm may linearly extend in a forward-rearward direction of the vehicle body in a plan view.

According to this constitution, the trailing arm linearly extends in the forward-rearward direction of the vehicle body in a plan view. For this reason, a bending rigidity (or a torsional rigidity) in the vehicle width direction centered in the upward-downward direction can be set comparatively low. Accordingly, the structure including the trailing arm between the vehicle body side attachment portion and the rotation center of the wheel hub can be set such that torsional vibration thereof is further facilitated. Thus, vibration from the wheel can be offset, and transfer of vibration to the vehicle body can be curbed.

In a fifth aspect, the vehicle body side attachment portion and the hub side attachment portion may be attached via a shaft member extending in a vehicle width direction of the vehicle body.

According to this constitution, the vehicle body side attachment portion and the hub side attachment portion are attached via the shaft member extending in the vehicle width direction of the vehicle body. Accordingly, while the degree of freedom for translational motion in the forward-rearward direction in the vehicle body side attachment portion and the hub side attachment portion is curbed, the degree of freedom for rotation centered in the forward-rearward direction can be enhanced. For this reason, in the structure including the trailing arm between the vehicle body side attachment portion and the rotation center of the wheel hub, while a high rigidity in the forward-rearward direction is maintained, torsional vibration thereof can be facilitated. Thus, vibration from the wheel can be offset, and transfer of vibration to the vehicle body can be curbed.

In a sixth aspect, the trailing arm may be a press-formed plate-shaped body.

According to this constitution, the trailing arm is a press-formed plate-shaped body. For this reason, compared to a structure formed to have a closed cross section as in a pipe shape, a bending rigidity (or a torsional rigidity) in the vehicle width direction centered in the upward-downward direction can be set comparatively low. Accordingly, the structure including the trailing arm between the vehicle body side attachment portion and the rotation center of the wheel hub can be set such that torsional vibration thereof is further facilitated. Thus, vibration from the wheel can be offset, and transfer of vibration to the vehicle body can be curbed.

According to the aspect of the present invention, it is possible to provide the suspension structure in which vibration of the vehicle body can be curbed.

### BRIEF DESCRIPTION OF THE DRAWINGS

FIG. 1 is a plan view of a suspension structure according to an embodiment.

FIG. 2 is a side view of the suspension structure according to the embodiment.

FIG. 3 is a front view of the suspension structure according to the embodiment.

### DESCRIPTION OF EMBODIMENTS

Hereinafter, with reference to the drawings, a suspension structure 100 according to an embodiment of the present invention will be described.

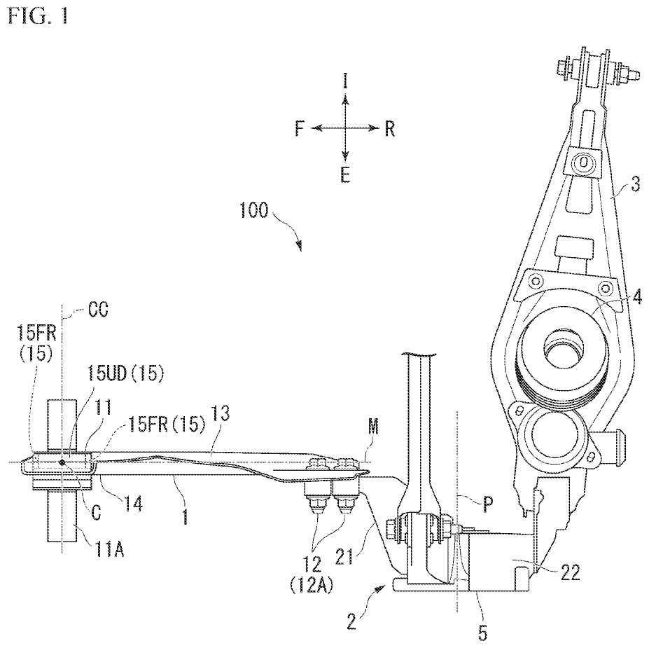

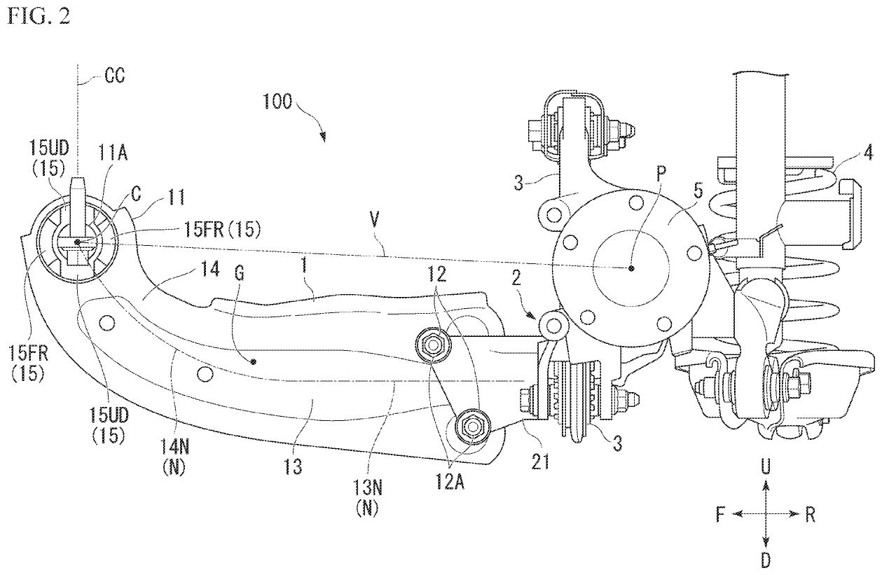

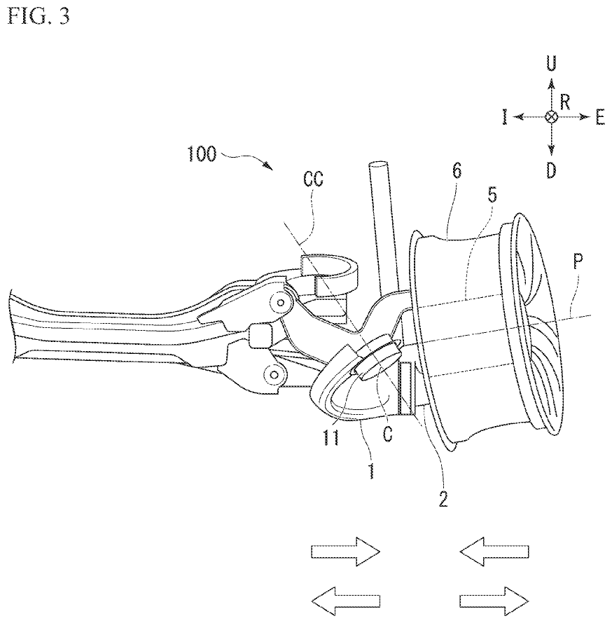

FIG. 1 is a plan view of the suspension structure 100 according to the embodiment. FIG. 2 is a side view of the suspension structure 100 according to the embodiment. FIG. 3 is a front view of the suspension structure 100 according to the embodiment. In FIGS. 1 and 2, illustration of a wheel 6 is omitted. FIG. 3 illustrates a situation in which the wheel 6 and a vehicle body side attachment portion 11 vibrate at phases opposite to each other and a trailing arm 1 is in torsional vibration. FIG. 3 particularly illustrates a state in which a lower end portion of the vehicle body side attachment portion 11 of the trailing arm 1 is displaced inward when a lower end portion of the wheel 6 is displaced outward.

In the drawings, the arrow F indicates the front side of a vehicle body, the arrow R indicates the rear side of the vehicle body, the arrow U indicates the upward side of the vehicle body, the arrow D indicates the downward side of the vehicle body, the arrow E indicates the exterior side of the vehicle body, and the arrow I indicates the interior side of the vehicle body. In addition, normally, the suspension structures 100 are symmetrically provided in a vehicle width direction with respect to the vehicle body. Hence, hereinafter, the suspension structure 100 on the left side will be representatively described.

<Suspension Structure>

As illustrated in FIGS. 1 to 3, the suspension structure 100 is a system for suspending the wheel 6 in the vehicle body (not illustrated). The suspension structure 100 includes the trailing arm 1 which couples a hub support portion 2 and the vehicle body to each other. In addition, the suspension structure 100 includes a link 3 which couples the hub support portion 2 and the vehicle body to each other, and a shock absorber 4 which includes a spring, a damper, and the like. The suspension structure 100 is particularly used for the wheel 6 which is a rear wheel.

<Hub Support Portion 2>

The hub support portion 2 rotatably supports a wheel hub 5 coupling the wheel 6 and an axle (not illustrated) via a suitable bearing (not illustrated). The wheel hub 5 rotatably supports the axle. The wheel hub 5 is fixed to the wheel 6. The wheel hub 5 integrally rotates with the wheel 6 and integrally vibrates with the wheel 6.

The hub support portion 2 has an annular main body 22 which supports the wheel hub 5, and a trailing arm attachment portion 21 to which a hub side attachment portion 12 of the trailing arm 1 is attached.

As illustrated in the side view in FIG. 2, the trailing arm attachment portion 21 extends from a rotation center P of the wheel hub 5 to a position separated downward. Specifically, in a side view, the trailing arm attachment portion 21 extends from the rotation center P of the wheel hub 5 to a position separated obliquely downward. Further, the trailing arm attachment portion 21 has an opening for inserting a shaft member 12A and attaching the trailing arm. In this manner, the trailing arm attachment portion 21 extends from the rotation center P of the wheel hub 5 to a position separated downward. Thus, while the minimum ground clearance is secured, the center of gravity G in the trailing arm 1 can be positioned below. In addition, the trailing arm 1 can perform torsional vibration.

In addition, as illustrated in the plan view in FIG. 1, the trailing arm attachment portion 21 extends inward from the main body 22 supporting the wheel hub 5. Specifically, the trailing arm attachment portion 21 extends obliquely inward from the main body 22 supporting the wheel hub 5. Accordingly, the trailing arm 1 can be disposed in a posture in a forward-rearward direction in a plan view. Thus, torsional vibration of the trailing arm 1 can be facilitated, vibration of the wheel 6 and vibration of the vehicle body side attachment portion 11 can be offset, and vibration of the vehicle body can be curbed.

<Trailing Arm>

As illustrated in FIGS. 1 to 3, the trailing arm 1 includes the vehicle body side attachment portion 11 attached to the vehicle body, and the hub side attachment portion 12 attached to the hub support portion 2.

Here, as illustrated in FIG. 2, the hub side attachment portion 12 is positioned below a shortest virtual line V connecting a center C of the vehicle body side attachment portion 11 and the rotation center P of the wheel hub 5 supported by the hub support portion 2. It is assumed that the center C is an intersection between an axial core CC of a shaft member 11A and a neutral surface M (refer to FIG. 1) when a bending moment in the vehicle width direction centered in an upward-downward direction in the vehicle body side attachment portion 11 acts.

In this manner, the hub side attachment portion 12 is positioned below the virtual line V. For this reason, the center of gravity G in the trailing arm 1 can be away from the center of vibration, and the trailing arm 1 can be likely to swing. In addition, the structure between the vehicle body side attachment portion 11 and the rotation center P of the wheel hub 5 can be set such that vibration in the vehicle width direction centered in the forward-rearward direction in the vehicle body side attachment portion 11 and vibration in the vehicle width direction centered in the forward-rearward direction (vibration at a lower end of the wheel 6) in the wheel hub 5 (or the wheel 6) have phases opposite to each other as illustrated in FIG. 3, by reducing a torsional rigidity. According to these, due to torsional vibration (which is also referred to as downward swing) in the structure including the trailing arm 1 between the vehicle body side attachment portion 11 and the rotation center P of the wheel hub 5, vibration in the vehicle body side attachment portion 11 and vibration in the wheel hub 5 (or the wheel 6) can be offset. Thus, it is possible to provide the suspension structure 100 in which vibration of the vehicle body can be curbed.

As illustrated in FIG. 2, the trailing arm 1 has a transverse portion 13 linearly extending in the forward-rearward direction of the vehicle body from the hub side attachment portion 12, and a hanging portion 14 extending downward from the vehicle body side attachment portion 11. The hanging portion 14 may extend obliquely downward from the vehicle body side attachment portion 11 toward the transverse portion 13 or may extend straight downward. As illustrated in FIG. 2, the hanging portion 14 may be curved downward in a convex shape. The hanging portion 14 may be smoothly connected to the transverse portion 13.

Specifically, a neutral surface N when a bending moment centered in the vehicle width direction acts on the trailing arm 1 has a transverse neutral surface 13N which linearly extends in the forward-rearward direction of the vehicle body from the hub side attachment portion 12, and a hanging neutral surface 14N which extends downward from the vehicle body side attachment portion 11.

The hanging neutral surface 14N may extend obliquely downward from the vehicle body side attachment portion 11 toward the transverse portion 13 or may extend straight downward. The hanging portion 14 may be curved downward in a convex shape or may be smoothly connected to the transverse portion 13.

In this manner, the trailing arm 1 has the transverse portion 13 linearly extending in the forward-rearward direction of the vehicle body from the hub side attachment portion 12, and the hanging portion 14 extending downward from the vehicle body side attachment portion 11. Thus, a rigidity of the trailing arm 1 with respect to a load from the forward-rearward direction can be enhanced, and the center of gravity G can be positioned below while the minimum ground clearance is secured. Accordingly, the structure including the trailing arm 1 between the vehicle body side attachment portion 11 and the rotation center P of the wheel hub 5 can be set such that torsional vibration thereof is facilitated. Thus, vibration from the wheel 6 can be offset, and transfer of vibration to the vehicle body can be curbed.

The vehicle body side attachment portion 11 has a bush 15 including a forward-rearward elastic body 15FR disposed in the forward-rearward direction of the vehicle body, and an upward-downward elastic body 15UD disposed in the upward-downward direction of the vehicle body. Further, the upward-downward elastic body 15UD has a lower hardness than the forward-rearward elastic body 15FR. The upward-downward elastic body 15UD may have a lower rigidity than the forward-rearward elastic body 15FR. The upward-downward elastic body 15UD may have a lower tensile strength than the forward-rearward elastic body 15FR. In this manner, the hardness of the upward-downward elastic body 15UD is caused to be lower than the hardness of the forward-rearward elastic body 15FR. Accordingly, a high rigidity in the forward-rearward direction can be maintained, and the bush 15 is likely to be distorted centered in the forward-rearward direction. Thus, the structure including the trailing arm 1 between the vehicle body side attachment portion 11 and the rotation center P of the wheel hub 5 can be set such that torsional vibration thereof is facilitated. Thus, vibration from the wheel 6 can be offset, and transfer of vibration to the vehicle body can be curbed.

As illustrated in FIG. 1, the trailing arm 1 linearly extends in the forward-rearward direction of the vehicle body in a plan view. For this reason, a bending rigidity (or a torsional rigidity) in the vehicle width direction centered in the upward-downward direction can be set comparatively low. Accordingly, the structure including the trailing arm 1 between the vehicle body side attachment portion 11 and the rotation center P of the wheel hub 5 can be set such that torsional vibration thereof is further facilitated. Thus, vibration from the wheel 6 can be offset, and transfer of vibration to the vehicle body can be curbed.

The vehicle body side attachment portion 11 and the hub side attachment portion 12 are attached via shaft members 11A and 12A extending in the vehicle width direction of the vehicle body. Accordingly, while the degree of freedom for translational motion in the forward-rearward direction in the vehicle body side attachment portion 11 and the hub side attachment portion 12 is curbed, the degree of freedom for rotation centered in the forward-rearward direction can be enhanced. For this reason, in the structure including the trailing arm 1 between the vehicle body side attachment portion 11 and the rotation center P of the wheel hub 5, while a high rigidity in the forward-rearward direction is maintained, torsional vibration thereof can be facilitated. Thus, vibration from the wheel 6 can be offset, and transfer of vibration to the vehicle body can be curbed.

The trailing arm 1 may be a press-formed plate-shaped body. For this reason, compared to a structure formed to have a closed cross section as in a pipe shape, a bending rigidity (or a torsional rigidity) in the vehicle width direction centered in the upward-downward direction can be set comparatively low. Accordingly, the structure including the trailing arm 1 between the vehicle body side attachment portion 11 and the rotation center P of the wheel hub 5 can be set such that torsional vibration thereof is further facilitated. Thus, vibration from the wheel 6 can be offset, and transfer of vibration to the vehicle body can be curbed. For example, the trailing arm 1 may be formed through press-forming of a steel plate.

The technical scope of the present invention is not limited to the foregoing embodiment, and various changes can be applied within a range not departing from the gist of the present invention.

Furthermore, within a range not departing from the gist of the present invention, the constituent elements in the foregoing embodiment can be suitably replaced with known constituent elements. In addition, the foregoing modification example may be suitably combined.

What is claimed is:

1. A suspension structure comprising:
a trailing arm that couples a hub support portion supporting a wheel hub to a vehicle body,
wherein the trailing arm includes
a vehicle body side attachment portion attached to the vehicle body, and
a hub side attachment portion attached to the hub support portion, and
wherein the hub side attachment portion is positioned below a shortest virtual line connecting a center of the vehicle body side attachment portion and a rotation center of the wheel hub.

2. The suspension structure according to claim 1,
wherein the trailing arm has
a transverse portion linearly extending in a forward-rearward direction of the vehicle body from the hub side attachment portion, and
a hanging portion extending downward from the vehicle body side attachment portion.

3. The suspension structure according to claim 1,
wherein the vehicle body side attachment portion has a bush including
a forward-rearward elastic body disposed in a forward-rearward direction of the vehicle body, and
an upward-downward elastic body disposed in an upward-downward direction of the vehicle body, and
wherein the upward-downward elastic body has a lower hardness than the forward-rearward elastic body.

4. The suspension structure according to claim 1,
wherein the trailing arm linearly extends in a forward-rearward direction of the vehicle body in a plan view.

5. The suspension structure according to claim 1,
wherein the vehicle body side attachment portion and the hub side attachment portion are attached via a shaft member extending in a vehicle width direction of the vehicle body.

6. The suspension structure according to claim 1,
wherein the trailing arm is a press-formed plate-shaped body.
